(19) United States
(12) Patent Application Publication
(10) Pub. No.: US 2016/0251263 A1
(43) Pub. Date: Sep. 1, 2016

(54) USE OF SURFACE-FUNCTIONALISED SILICIC ACIDS AS ADDITIVE FOR REACTION RESIN COMPOSITIONS AND RESIN AND HARDENER COMPOSITIONS CONTAINING SAME

(71) Applicant: Hilti Aktiengesellschaft, Schaan (LI)

(72) Inventors: Armin Pfeil, Kaufering (DE); Memet-Emin Kumru, Augsburg (DE)

(21) Appl. No.: 14/429,549

(22) PCT Filed: Sep. 19, 2013
(86) PCT No.: PCT/EP2013/069422

§ 371 Date: Mar. 19, 2015

(30) Foreign Application Priority Data
Sep. 21, 2012 (DE) 10 2012 216 972.5

(51) Int. Cl. C04B 26/14; C09C 1/30; C04B 24/42

(52) U.S. Cl. CPC C04B 26/14; C04B 24/42; C09C 1/3063; C04B 2103/0086

(57) ABSTRACT

A use of a surface-functionalised silicic acid, wherein the silicic acid bears on its surface organic multidentate ligands, which can form, as an additive for the resin and/or hardener component in a multi-component reaction resin composition, a chelate complex with metal or metal compounds is provided. Resin and hardener compositions can thus be provided which are storage-stable in the presence of traces of metal compounds.

The present invention relates to the use of surface-functionalized silicic acids as additive for the components of one or multicomponent inorganically filled reaction resin compositions, which may be used, in particular, for manufacturing reaction resin mortars, as well as inorganically filled resin components and/or hardener components containing this additive.

### BACKGROUND

Inorganically filled reaction resin compositions are known for numerous applications, in particular for applications in construction, such as gluing, sealing, coating and for fixing anchoring means and the like. Such reaction resin compositions are described, for example, in DE 39 40 309 A1, in DE 4 231 161 A1, and in EP 2 357 162 A1.

In order to adjust the viscosity and the desired product properties, the resin component usually contains reactive diluents, i.e., low viscosity compounds, such as monomers or oligomers, which may participate in the hardening reaction of the resin, and are incorporated in the resin. Depending on the hardening system, the hardener component contains a radical initiator and, optionally, a phlegmatizer in this case as a hardening agent for radically hardenable resins, or amines as a hardening agent for epoxy resins, for example, and frequently also solvents for adjusting the viscosity of the components.

To adjust the required mixing ratio in the case of multi-component systems, and/or as fillers, the reaction resin compositions contain, among other things, inorganic supplements, in particular, mineral or mineral-like fillers, such as quartz, glass, sand, quartz sand, quartz powder, porcelain, corundum, ceramic, talcum, silicic acid (for example, pyrogenic silicic acid), silicates, clay, titanium dioxide, chalk, heavy spar, feldspar, basalt, aluminum hydroxide, granite or sandstone. In addition, the compositions also often contain hydraulic-setting supplements, such as plaster, quicklime or cement, for example, aluminate cement or Portland cement, as described, for example, in DE 4 231 161 A1.

The disadvantage of the known systems is that as a result of the reactive diluents, the (inert) solvents or the amine, transition metal compounds, such as iron compounds, aluminum compounds, copper compounds and manganese compounds, in particular oxides contained as impurities in the inorganic fillers, may be separated out. This occurs, in particular, in compounds which may make metal compounds complex, such as, for example, 2-methyl-1,5-pentanediamine or 2-(acetoacetoxy)ethyl methacrylate. The separated metal compounds destabilize the peroxides used as hardeners for radically based systems, so that the storage stability of the components containing the peroxide is adversely affected. However, even the storage stability of the resin component, regardless of whether it involves radically hardenable systems or epoxy-based systems, may be adversely affected by the released metals or metal compounds, and may diminish.

Accordingly, it was previously necessary to ensure that the fillers and additives used included preferably small traces of metal compounds, which required the use of fillers and additives having a high degree of purity in order to achieve the desired storage stability of the components.

### SUMMARY OF THE INVENTION

It is an object of the present invention to provide inorganically filled resin components and/or hardener components having good storage stability, which, in particular when using fillers and additives exhibiting a higher content of metal traces, such as those having technical grade purity, have good storage stability and are therefore more economical to manufacture.

The expression “transition metal compound(s)” is intended within the meaning of the present invention to encompass compounds of transition metals, i.e., chemical elements having the ordinal numbers from 21 through 30, 39 through 48, 57 through 80 and 89 through 112, such as metal complexes, metal salts, metal oxides, metal sulfides and the like.

The present invention provides a surface-functionalized silicic acid as an additive for the resin component and/or hardener component of a multi-component reaction resin composition, the silicic acid bearing on its surface organic, polydentate ligands, which may form a chelate complex with metal compounds.

“Additives” within the meaning of the present invention are understood to mean substances or compounds, which are added in small quantities to products (in this case: resin components and/or hardener components), in order to obtain or to improve particular properties of the products, in particular, in order to achieve a positive effect, such as storage stability, prior to the use phase. “Surface-functionalized” within the meaning of the present invention means that the chemical structure at the surface has been modified from its original state.

The inventors have found that the storage stability of a hardener component, which contains an aliphatic diamine and/or a peroxide, such as that of a hybrid binding agent having the diamine as the hardening agent for an epoxy compound, and the peroxide as a hardening agent for a radically hardenable compound, as is described in EP 2 357 162 A1, may be increased significantly, if the composition is augmented by a surface-functionalized silicic acid, the surface of which has been functionalized so that its surface bears organic, polydentate ligands, which may form a chelate complex with metal compounds. This is observed, even when fillers and mineral additives having technical grade purity are used. In this case, even a small amount of the surface-functionalized silicic acid is sufficient.

This surface-functionalized silicic acid has the advantage that the metal or metal compounds separated out by the reactive diluents, the (inert) solvents or the amines, form stable complexes with the ligands appended to the silicic acid, so that a destabilization of the resins or the radical initiators is prevented. In such a case, the chelate complexes formed with the ligands of the surface-functionalized silicic acid must be more stable, as compared to the compounds or complexes, which are formed with the reactive diluents, (inert) solvents and/or the amines used as hardeners. Another advantage of the present invention is that the surface-functionalized silicic acids corresponding to the frequently used pyrogenic silicic acids are an inert filler and, therefore, do not have to be separated off. In addition to their function as metal separators, they are used as fillers, without negatively influencing the properties of the reaction resin compositions. Instead, they assist in the adjustment of the rheological properties of the components.

As a result, it is possible to use fillers and/or mineral additives, which contain transition metal compounds, having a lower degree of purity, such as, for example, those having technical grade purity, without having to change the formulation of the reaction resin composition, which makes them simpler and more economical to manufacture.

Suitable surface-modified silicic acids as transition metal separators bear organic residues on their surfaces, which function as polydentate ligands and, with the metal compounds, form a stable chelate complex. More precisely, the surface-functionalized silicic acid is a compound of the general formula (I)

a. [O_{4/2}Si]ₐ[O_{3/2}SiCH₂(CR³R⁴)ₘX]_{b}[O_{3/2}SiCH₂(CR³R⁴)ₙY]_{c}[O_{3/2}SiV]_{d} (I)

in which X is selected from among NRR², NR[(CH₂)ₚNR¹]ᵢR², SR, S(CH²)ₑSR, S(CH₂)_{f}U, S[(CH₂)ⱼS]ₜR, S[(CH₂)ₑS]ₜ(CH₂)ₛZ, NRC(S)NR¹H, SCH₂CH(NHR)CO₂E, SCH₂CH(CO₂E)CH₂CO₂E, S(CH₂)OR, S(CH₂)ᵤC(O)W, S(CH₂)NRC(S)NR¹H and OCH₂CH(OH)CH₂NR[(CH₂)ₚNR¹]ᵢR³, in which U represents a heteroaromatic ring, Z represents SiO_{3/2}, or a heteroaromatic ring, E represents hydrogen, C₁-C₁₀-alkyl or a metal ion M, and W represents OH, OR, OM or NR[(CH₂)ₚNR¹]ᵢR².

If c is greater than 0, Y is selected from among NRR², NR[(CH₂)ₚNR¹]R², SR, S(CH₂)ₑSR, S(CH₂)_{f}U, S[(CH₂)ⱼS]ₜR or S[(CH₂)ₑS]ₜ(CH₂)ₛZ.

R, R¹, R³ and R⁴ are independently selected from among hydrogen, C₁-C₂₂-alkyl, C₁-C₂₂-aryl and C₁-C₂₂-alkylaryl. R² is selected from among hydrogen, C₁-C₂₂-alkyl or C₂-C₁₀-alkyl-Si(O)_{3/2}.

l, s, t and u represent independently whole numbers from 1 through 100, i represents a whole number from 1 through 10,000; m and n represent independently a whole number from 1 through 100 and e, f, j and p represent independently a whole number from 2 through 20.

V represents an optionally substituted group, which is selected from among C₁-C₂₂-alkyl, C₂-C₂₂-alkenyl, C₂-C₂₂-alkinyl, aryl, C₁-C₂₂-alkylaryl, C₁-C₂₂-alkyl, which is substituted by a sulfide, sulfoxide, sulfone, amine, polyalkylamine, phosphine or other phosphorous-containing groups, or contains these groups as part of the hydrocarbon chain.

The free valences of the oxygen atoms of the silicate are saturated by one or multiple groups, which are selected from among a silicon atom of other compounds of the general formula (I), hydrogen, a linear or branched C₁-C₂₂-alkyl group, an end group R⁵₃MO¹O_{1/2}, a cross-linking bridge member or a chain R⁵_{q}M¹(OR⁶)_{g}O_{k/2} or Al(OR⁶)₃₋ₕO_{h/2} or R⁵Al(OR⁶)₂₋ᵣO_{r/2}, in which M¹ represents Si or Ti, R⁵ and R⁶ being independently selected from among a linear or branched C₁-C₂₂-alkyl group, aryl group and C₁-C₂₂-alkylaryl group. k represents a whole number from 1 through 3, q represents 1 or 2 and g represents a whole number from 0 through 2, g+k+q being 4, h representing a whole number from 1 through 3 and r representing 1 or 2. The free valences may also be saturated by an oxometal binding system, the metal being zirconium, boron, magnesium, iron, nickel or a lanthanide.

a, b, c and d represent whole numbers, so that the ratio b:a is between 0.00001 and 100,000, and a and b are always greater than 0. If c is greater than 0, the ratio c:a+b is between 0.00001 and 100,000. If d is greater than zero, the ratio d:a+b is between 0.00001 and 100,000.

If an end group and/or a cross-linking agent or a polymer chain is/are used, the ratio of the end group, of the cross-linking agent or of the polymer chains at a+b+c+d is preferably between 0 and 999:1, preferably between 0.001 and 999:1, and particularly preferably between 0.01 and 99:1.

Preferable compounds of the general formula (I) are those in which X is selected from among NRR², NR[(CH₂)ₚNR¹]ᵢR², SR, S(CH²)ₑSR, S[(CH₂)ⱼS]ₜR, S[(CH₂)ₑS]ₜ(CH₂)ₛZ, NRC(S)NR¹H, S(CH₂)ᵤC(O)W, S(CH₂)ⱼNRC(S)NR¹H and OCH₂CH(OH)CH₂NR[(CH₂)ₚNR¹]ᵢR^{3,} in which Z represents SiO_{3/2} or a heteroaromatic ring, and W represents NR[(CH₂)ₚNR¹]ᵢR².

In one preferred specific embodiment, if c is greater than 0, Y is selected from among NRR², NR[(CH₂)ₚNR¹]ᵢR², SR, S(CH₂)ₑSR, S[(CH₂)ⱼS]ₜR or S[(CH₂)ₑS]ₜ(CH₂)ₛZ, R and R¹ being independently selected from among hydrogen, C₁-C₁₀-alkyl, C₁-C₂₂-aryl and C₁-C₂₂-alkylaryl. R² is selected from among hydrogen, C₁-C₂₂-akyl or C₂-C₁₀-alkyl-Si(O)_{3/2}, and R³ and R⁴ represent hydrogen. s, t and u represent independently whole numbers from 1 through 20, i represents a whole number from 1 through 10,000, m and n represent independently a whole number from 1 through 10 and e, j and p represent independently a whole number from 2 through 20.

V preferably represents an optionally substituted group, which is selected from among C₁-C₂₂-akyl, C₂-C₂₂-alkenyl, C₂-C₂₂-alkinyl, aryl, C₁-C₂₂-alkylaryl, C₁-C₂₂-akyl, which is substituted by a sulfide, a sulfoxide, a sulfone, an amine or a polyalkylamine, or which contains these groups as part of the hydrocarbon chain.

The free valences of the oxygen atoms of the silicate are preferably saturated by one or multiple groups, which are selected from among a silicon atom of one of the other compounds of the general formula (I), hydrogen, a linear or branched C₁-C₁₀-alkyl group and an end group R⁵₃M¹O_{1/2} of a cross-linking bridge member or a chain R⁵_{q}M¹(OR⁶)_{g}O_{k/2} or Al(OR⁶)₃₋ₕO_{h/2} or R⁵Al(OR⁶)₂₋ᵣO_{r/2}, in which M¹ represents Si or Ti, and in which R⁵ and R⁶ are independently selected from a linear or branched C₁-C₁₂-alkyl group, aryl group and C₁-C₁₀-alkylaryl group. k represents a whole number from 1 through 3, q represents 1 or 2 and g represents a whole number from 0 through 2, g+k+q being 4, h representing a whole number from 1 through 3 and r representing 1 or 2. The free valences may also be saturated by an oxometal binding system, the metal being zirconium, boron, magnesium, iron, nickel or a lanthanide.

a, b, c and d preferably represent whole numbers, so that the ratio b:a is between 0.00001 and 100, and a and b are always greater than 0. If c is greater than 0, the ratio c:a+b is between 0.00001 and 100. If d is greater than zero, the ratio of d:a+b is between 0.00001 and 100.

In one particularly preferred specific embodiment, the surface-functionalized silicic acid contains two or more of these preferred features in combination.

If an end group and/or a cross-linking agent or a polymer chain is/are used, the ratio of the end group, the cross-linking agent or the polymer chain to a+b+c+d is between 0 and 999:1, preferably between 0.001 and 999:1 and particularly preferably between 0.01 and 99:1.

Particularly preferred compounds of the general formula (I) include those in which X is selected from among NRR², NH[(CH₂)ₚNH]ᵢR², SR, S(CH₂)ₑSH, S[(CH₂)ᵢS]ₜH, S[(CH₂)ₑS]ₜ(CH₂)ₛZ, NHC(S)NR¹H, S(CH₂)ᵤC(O)W, S(CH₂)ⱼNRC(S)NR¹H and OCH₂CH(OH)CH₂NH[(CH₂)ₚNH]H, in which Z represents SiO_{3/2} or a heteroaromatic ring and W represents NH[(CH₂)ₚNH]ᵢH. If c is greater than 0, Y is selected from among NRR², NH[(CH₂)ₚNH]ᵢR², SR, S(CH₂)ₑSH, S[(CH₂)ⱼS]ₜH or S[(CH₂)ₑS]ₜ(CH₂)ₛZ.

R and R¹ are independently selected from among hydrogen, C₁-C₁₀-alkyl, C₁-C₂₂-aryl and C₁-C₂₂-alkylaryl; R² is selected from among hydrogen, C₁-C₁₂-alkyl or C₃-alkyl-Si(O)_{3/2}, and R³ and R⁴ represent hydrogen. s, t and u represent independently whole numbers from 1 through 10, i represents a whole number from 1 through 10,000, m and n represent independently whole numbers from 1 through 5 and e, j, s and p represent independently whole numbers from 2 through 20.

V represents an optionally substituted group, which is selected from among C₁-C₁₂-alkyl, C₂-C₂₂-alkenyl, C₁-C₂₂-alkyl, which is substituted by an amine or contains this group as part of the hydrocarbon chain.

The free valences of the oxygen atoms of the silicate are saturated by one or more groups, which are selected from among a silicon atom of one of the other compounds of the general formula (I), hydrogen, a linear or branched C₁-C₁₀-alkyl group and an end group R⁵₃SiO_{1/2} of a cross-linking bridge member or of a chain R⁵_{q}(Si(OR⁶)_{g}O_{k/2} or Al(OR⁶)₃₋ₕO_{h/2} or R⁵Al(OR⁶)₂₋ᵣO_{r/2}, in which R⁵ and R⁶ are independently selected from among a linear or branched C₁-C₆-alkyl group and an aryl group. k is a whole number from 1 through 3, q is 1 or 2 and g is a whole number between 0 and 2, so that g+k+q is 4. h is a whole number between 1 and 3 and r is 1 or 2.

a, b, c and d represent whole numbers, so that the ratio b:a is between 0.00001 through 10, and a and b are always greater than 0. If c is greater than 0, the ratio c:a+b is between 0.00001 and 10. If d is greater than zero, the ratio d:a+b is between 0.00001 and 10.

If an end group and/or a cross-linking agent or a polymer chain is/are used, the ratio of the end group, of the cross-linking agent or of the polymer chains to a+b+c+d is between 0 and 999:1, preferably between 0.001 and 999:1 and particularly preferably between 0.01 and 99:1.

In one particularly preferred specific embodiment of the present invention, the compounds of the general formula (I) are those in which a and b represent whole numbers, so that the ratio b:a is between 0.00001 to 10, and c and d are 0. X is selected from among NR[(CH₂)ₚNR¹]ᵢH, S(CH₂)ₑSH, S(CH₂)ᵤC(O)W, S(CH₂)ⱼNRC(S)NR¹H, in which W represents NH[(CH₂)ₚNH]ᵢH, R and R₁ being independently selected from among hydrogen or C₁-alkyl, R₃ and R₄ representing hydrogen, u and i representing independently 1 or 2, e, j and p representing independently 2 or 3. The free valences of the oxygen atoms of the silicate are saturated by one or more groups, which are selected from among a silicon atom of one of the other compounds of the general formula (I), hydrogen, a linear or branched C₁-C₁₂-alkyl group and an end group R⁵₃SiO_{1/2}, of a cross-linking bridge member or of a chain R⁵_{q}Si(OR⁶)_{g}O_{k/2} or Al(OR⁶)₃₋ₕO_{h/2} or R⁵Al(OR⁶)₂₋ᵣO_{r/2}, in which R⁵ and R⁶ are independently selected from a linear or branched C₁-C₆-akyl group, an aryl group and a C₁-C₂₂-alkylaryl group

Pyrogenically manufactured surface-functionalized silicic acids (also surface-functionalized pyrogenic silicic acids or surface-functionalized, pyrogenically manufactured silicic acids) are particularly preferred.

The manufacture of the surface-functionalized silicic acids used according to the present invention is described, for example, in DE 10 2006 048 509 A1, in WO 2009/049911 A1 and in WO 2011/128061 A1. These are in part commercially available.

By using the above-described surface-functionalized silicic acids, it is possible to manufacture more economically reaction resin components and hardening components of two or multi-component reaction resin compositions, which have storage stability.

Thus, one subject matter of the present invention is a resin component which is based on radically hardenable compounds and/or is epoxy-based, which is characterized in that it contains as an additive a surface-functionalized silicic acid as described above.

Similarly, another subject matter of the present invention is a peroxide-based or amine-based hardening component, which is characterized in that it contains as an additive a surface-functionalized silicic acid as described above.

The nomenclature used below to identify the radically polymerizable compounds “(meth)acryl . . . / . . . (methy) acryl . . . ” means that these designations are intended to cover both the “methacryl . . . / . . . methacryl . . . ”—as well as the “acryl . . . / . . . acryl . . . ”—compounds.

Radically hardenable compounds encompass a variety of compounds known by those skilled in the art and commercially available for this purpose. According to the present invention, ethylenically unsaturated compounds, compounds having carbon-carbon triple bonds and thiol-Yn/En resins are suitable.

Of these compounds, the group of ethylenically unsaturated compounds is preferred, which includes styrene and derivatives thereof, (meth)acrylate, vinyl ester, unsaturated polyester, vinyl ether, ally ether, itaconate, dicyclopentadiene compounds and unsaturated fats, of which unsaturated polyester resins and vinyl esters, in particular, are suited and are described, for example, in the applications EP 1 935 860 A1, DE 195 31 649 A1, WO 02/051903 A1 and WO 10/108939 A1. Vinyl ester resins are most preferred due to their hydrolytic stability and excellent mechanical properties.

Examples of suitable unsaturated polyesters, which may be used in the resin mixture according to the present invention, are divided into the following categories, as they have been classified by M. Malik et al., in J. M. S.—Rev. Macromol. Chem. Phys., C40(2 and 3), pp 139-165 (2000):

(1) Ortho-resins: these are based on phthalic anhydride, maleic anhydride or fumaric acid and glycols, such as 1,2-propylene glycol, ethylene glycol, diethylene glycol, triethylene glycol, 1,3-propylene glycol, dipropylene glycol, tripropylene glycol, neopentyl glycol or hydrogenated bisphenol-A;
(2) Iso-resins: these are manufactured from isophthalic acid, maleic anhydride or fumaric acid and glycols. These resins may contain higher amounts of reactive diluents than the ortho resins;
(3) Bisphenol-A-fumarates: these are based on ethoxylated bisphenol-A and fumaric acid;
(4) HET acid resins (hexachloro-endo-methylene-tetrahydrophthalic acid resins): are resins which are obtained from chlorine/bromine containing anhydrides or phenols during the manufacture of unsaturated polyester resins.

In addition to these resin classes, it is also possible to differentiate the so-called dicyclopentadiene resins (DCPD resins) as unsaturated polyester resins. The class of the DCDP resins is obtained either by modification of one of the aforementioned resin types by a Diels-Alder reaction with cyclopentadiene, or alternatively, they are obtained by an initial reaction of a dicarbonic acid, for example, maleic acid, with dicyclopentadienyl, and subsequently by a second reaction, the normal manufacture of an unsaturated polyester resin, the latter being referred to as a DCPD maleate resin.

The unsaturated polyester resin preferably has a molecular weight Mn in the range of 500 to 10,000 Dalton, more strongly preferred in the range of 500 to 5,000 and even more strongly preferred, in the range of 750 to 4,000 (according to ISO 13885-1). The unsaturated polyester resin has an acid value in the range of 0 to 80 mg KOH/g of resin, preferably in the range of 5 to 70 mg KOH/g of resin (according to ISO 2114-2000). If a DCPD resin is used as an unsaturated polyester resin, the acid value is preferably 0 to 50 mg KOH/g of resin.

Vinyl ester resins within the meaning of the present invention are oligomers, prepolymers or polymers having at least one (meth)acrylate end group, so-called (meth)acrylate functionalized resins, which also include urethane (meth)acrylate resins and epoxy(meth)acrylate.

Vinyl ester resins having unsaturated groups only in the end position are obtained, for example, by reacting epoxy oligomers or epoxy polymers (for example, bisphenol-A-diglycidyl ether, phenol-novolak-type epoxies or epoxy oligomers based on tetrabrombisphenol A) with, for example, (meth)acrylic acid or (meth)acrylamide. Preferred vinyl ester resins are (meth)acrylate-functionalized resins and resins obtained by reacting an epoxy oligomer or epoxy polymer with methacrylic acid or methacrylamide, preferably with methacrylic acid. Examples of such compounds are known from the applications U.S. Pat. No. 3,297,745 A, U.S. Pat. No. 3,772,404 A, U.S. Pat. No. 4,618,658 A, GB 2 217 722 A1, DE 37 44 390 A1 and DE 41 31 457 A1.

Particularly suitable and preferred as vinyl ester resin are (meth)acrylate-functionalized resins, which are obtained, for example, by reacting difunctional and/or higher functional isocyanates with suitable acryl compounds, optionally with the participation of hydroxyl compounds, which contain at least two hydroxyl groups, as described in DE 3940309 A1.

Isocyanates used may be aliphatic (cyclical or linear) and/or aromatic di-functional or higher functional isocyanates or prepolymers thereof. Such compounds are used to increase the wetting capacity and, thus, to improve adhesion properties. Aromatic difunctional or higher function isocyanates or prepolymers thereof are preferred, aromatic difunctional or higher functional prepolymers being particularly preferred. For example, toluene diisocyanate (TDI), diisocyanate diphenyl methane (MDI) and polymeric diisocyanate diphenyl methane (pMDI) for enhancing the chain reinforcement and hexane diisocyanate (HDI) and isophorone diisocyanate (IPDI), which improve flexibility, may be cited, among which polymeric diisocyanate diphenyl methane (pMDI) is especially particularly preferred.

Suitable acryl compounds are acrylic acid and acrylic acids substituted on carbon residue, such as methacrylic acid, esters of the acrylic acid containing hydroxyl groups or methacrylic acids having multi-valent alcohols, pentaerythrit triacrylate, glycerol diacrylate, such as trimethylol propane diacrylate, neopentyl glycol monoacrylate. Acryl acid hydroxyl alkyl ester or methacrylic acid hydroxyl alkyl ester, such as hydroxyl ethyl (meth)acrylate, hydroxypropyl (meth)acrylate, polyoxy ethylene (meth)acrylate, polyoxy propylene (meth)acrylate are preferred, particularly since such compounds serve as a steric hindrance to the saponification reaction.

Suitable hydroxy compounds that may be optionally used are bivalent or higher valent alcohols, for example, derivatives of the ethylene oxide or propylene oxide, such as ethanediol, diethylene glycol or triethylene glycol, propanediol, dipropylene glycol, other dioles, such as 1,4-butanediol, 1,6-hexanediol, neopentyl glycol, diethanolamine, also bisphenol A or F or oxethylating products and/or hydrating products or halogenating products thereof, higher valent alcohols, such as glycerin, trimethylol propane, hexanetriol and pentaerythrite, polyethers containing hydroxyl groups, for example, oligomers of aliphatic or aromatic oxiranes and/or higher cyclical ethers, such as ethylene oxide, propylene oxide, styrene oxide and furan, polyethers, which contain aromatic structural units in the main chain, such as those of bisphenol A or F, polyesters containing hydroxyl groups on the basis of the aforementioned alcohols or polyethers and dicarbonic acids or their anhydrides, such as adipinic acid, phthalic acid, tetrahydrophthalic acid or hexahydrophthalic acid, het acid, maleic acid, fumaric acid, itaconic acid, sebacic acid and the like. Particularly preferred are hydroxyl compounds having aromatic structural units for chain reinforcement of the resin, hydroxyl compounds, which contain unsaturated structural units, such as fumaric acid, for enhancing the cross-linking density, branched or stellate hydroxyl compounds, in particular trivalent or higher valent alcohols and/or polyethers or polyesters, which contain their structural units, branched or stellate urethane (meth)acrylate for achieving lower viscosity of the resins or solutions thereof in reactive diluents and higher reactivity and cross-linking density.

The vinyl ester resin preferably has a molecular weight Mn in the range of 500 to 3000 Dalton, more strongly preferably 500 to 1,500 Dalton (according to ISO 13885-1). The vinyl ester resin has an acid value in the range of 0 to 50 mg KOH/g of resin, preferably in the range of 0 to 30 mg KOH/g of resin (according to ISO 2114-2000).

All of these resins, which may be used according to the present invention, may be modified according to methods known to those skilled in the art, in order, for example, to achieve lower acid values, hydroxide values or anhydride values, or rendered more flexible by introducing flexible units into the basic structure, and the like.

In addition, the resin may also contain other reactive groups, which may be polymerized with a radical initiator, such as peroxides, for example, reactive groups, which are derived from the itaconic acid, citraconic acid and allylic groups and the like.

Hardenable epoxies include a variety of compounds known to those skilled in the art and commercially available for this purpose, which contain, on average, more than one epoxy group, preferably, on average, two or more epoxy groups, per molecule. These epoxy compounds (epoxy resins) in this case may be both saturated and unsaturated, as well as aliphatic, alicyclic, aromatic or heterocyclic, and may also include hydroxyl groups. They may also contain substituents which cause no disruptive secondary reactions under the mixture and reaction conditions, for example, alkyl substituents or aryl substituents, ether groups and the like. Trimeric and tetrameric epoxies are also suitable within the scope of the present invention. Suitable polyepoxy compounds are described, for example, in Lee, Neville, Handbook of Epoxy Resins 1967. The epoxies are preferably glycidyl ethers, which are derived from multivalent alcohols, in particular bisphenols and novolaks. The epoxy resins have an epoxy equivalent weight (EEW) of 120 to 2,000 g/equivalent, preferably of 140 to 400 g/equivalent. Mixtures of multiple epoxy resins may also be used. Liquid diglycidyl ethers based on bisphenol A and/or F having an epoxy equivalent weight of 180 to 190 g/equivalent are particularly preferably used. Mixtures of multiple epoxy resins may also be used.

Multivalent phenols include, for example, resorcinol, hydrochinone, 2, 2-bis-(4-hydroxyphenyl)-propane (bisphenol A), isomeric mixtures of dihydroxy phenyl methane (bisphenol F), tetrabromobisphenol A, novolaks, 4,4′-dihydroxy phenyl cyclohexane, 4,4′-dihydroxy-3-3′-dimethyl diphenyl propane and the like.

The epoxy is preferably a diglycidyl ether of bisphenol A or of bisphenol F or a mixture thereof.

The hardening of the radically hardenable compound is advantageously initiated with a peroxide. An accelerator may be used in addition to the peroxide. All of the peroxides known to those skilled in the art, which are used for hardening unsaturated polyester resins and vinyl ester resins, may be used. Such peroxides include organic and inorganic peroxides, either liquid or solid, whereby hydrogen peroxide may also be used. Examples of suitable peroxides are peroxycarbonates (of the formula —OC(O)OO—), peroxyesters (of the formula —C(O)OO—), diacylperoxides (of the formula —C(O)OOC(O)—), dialkylperoxides (of the formula —OO—) and the like. These may be present as oligomers or polymers. A complete range of examples for suitable peroxides is described, for example, in paragraph [0018] of US application 2002/0091214-A1.

Peroxides are preferably selected from the group of organic peroxides. Suitable organic peroxides are: tertiary alkyl hydroperoxides, such as tert-butyl hydroperoxide and other hydroperoxides, such as cumen hydroperoxide, peroxyester or peracids, such as tert-butyl perester, benzoyl peroxide, peracetate and perbenzoate, lauryl peroxide, including (di)peroxyesters, perethers, such as peroxy diethyl ether, perketones, such as methyl ethyl ketone peroxide. The organic peroxides used as hardeners are often tertiary peresters or tertiary hydroperoxides, i.e., peroxide compounds having tertiary carbon atoms, which are bonded directly to a —O—O-acyl- or —OOH group. However, other mixtures of these peroxides with other peroxides may also be used according to the present invention. The peroxides may also be mixed peroxides, i.e., peroxides which include two different peroxide bearing units in one molecule. Benzoyl peroxide (BPO) or tertiary butyl peroxybenzoate is preferably used for hardening.

The at least one amine used for hardening the compound, which may react with an amine, is advantageously a primary and/or secondary amine. The amine may be aliphatic, cycloaliphatic, aromatic and/or araliphatic, and may bear one or multiple amino groups (hereinafter referred to as polyamine). The polyamine bears preferably at least two primary aliphatic amino groups. Furthermore, the polyamine may also bear amino groups having primary, secondary or tertiary character. Also equally suitable are polyaminoamides and polyalkylene oxide-polyamines or amine adducts, such as amine epoxy resin adducts or mannich bases. Amines which contain both aromatic and aliphatic residues are defined as araliphatic.

Suitable amines, without limiting the scope of the present invention are, for example: 1, 2-diaminoethane(ethylenediamine), 1, 2-propanediamine, 1,3-propanediamine, 1,4-diaminobutane, 2, 2-diemthyl-1,3-propanediamine (neopentadiamine), diethylaminopropylamine (DEAPA), 2-methyl-1,5-diaminopentane, 1,3-diaminopentane, 2,2,4- or 2,4,4-trimethyl-1,6-diaminohexane and mixtures thereof (TMD), 1-amino-3-aminomethyl-3,5,5-trimethyl cyclohexane, 1,3-bis(aminomethyl)-cyclohexane, 1,2-bis(aminomethyl)cyclohexane, hexamethylenediamine (HMD), 1,2- and 1,4-diaminocyclohexane (1,2-DACH and 1,4-DACH), bis(4-aminocyclohexyl)methane, bis(4-amino-3-methylcyclohexyl)methane, diethyelentriamine (DETA), 4-azaheptane-1,7-diamine, 1,11-diamino-3,6,9-troxundecane, 1,8-diamino-3,6-dioxaoctane, 1,5-diamino-methyl-3-azapentane, 1,10-diamino-4,7-dioxadecane, bis(3-aminopropyl)amine, 1,13-diamino-4,7,10-trioxatridecane, 4-aminomethyl-1,8-diaminooctane, 2-butyl-2-ethyl-1,5-diaminopentane, N,N-bis(3-aminopropyl)methylamine, triethylenetetramine (TETA), tetraethylenepentamine (TEPA), pentaethylenehexamine (PEHA), bis(4-amino-3-methylcyclohexyl)methane, 1,3-benzenedimethanamine (m-xylyenediamine, mXDA), 1,4-benzenedimethanamine (p-xylylenediamine, pXDA), 5-(aminomethyl)bicyclo[[2.2.1]hept-2yl]methylamine (NBDA, norbomandiamine), dimethyldipropylenetriamine, dimethylaminopropyl-aminopropylamine (DMAPAPA), 3-aminomethyl-3,5,5-trimethylcyclohexylamine (isophoronediamine (IPD)), diaminodicyclohexylmethane (PACM), mixed polycyclical amines (MPCA) (for example Ancamine® 2168), dimethyldiaminodicyclohexylmethane (Laromin® C260), 2,2-bis(4-aminocyclohexyl)propane, (3(4),8(9)bis(aminomethyl)dicyclo[5.2.1.0^{2,6}]decane (isomeric mixtures, tricyclic primary amines; TCD-diamine).

Polyamines are preferred, such as 2-methylpentanediamine (DYTEK A®), 1-amino-3-aminomethyl-3,5,5-trimethylcyclohexane (IPD), 1,3-benzenedimethanamine (m-xylylenediamine, mXDA), 1,4-benzenedimethanamine (p-xylylenediamine, PXDA), 1,6-diamino-2.2.4-trimethylhexane (TMD), diethylenetriamine (DETA), triethylenetetramine (TETA), tetraethylenepentamine (TEPA), pentaethylenehexamine (PEHA), N-ethylaminopiperazine (N-EAP), 1,3-bisaminomethylcyclohexane (1,3-BAC), (3(4),8(9)bis(aminomethyl)dicyclo[5.2.1.0^{2,6}]decane (isomeric mixture, tricyclic primary amines; TCD-diamine), 1,14-diamino-4,11-dioxatetradecane, dipropylenetriamine, 2-methyl-1,5-pentanediamine, N,N′-dicyclohexyl-1,6-hexanediamine, N,N′-dimethyl-1,3-diaminopropane, N,N′diethyl-1,3-diaminopropane, N,N-dimethyl-1,3-diaminopropane, secondary polyoxypropylenediamines and triamines, 2,5-diamino-2,5-dimethylhexane, bis-(aminomethyl)tricyclopentadiene, 1,8-diamino-p-methane, bis-(4-amino-3,5-dimethylcyclohexyl)methane, 1,3-bis(aminomethyl)cyclohexane (1,3-BAC), dipentylamine, N-2-(aminoethyl)piperazine (N-AEP), N-3-(aminopropyl)piperazine, piperazine.

In this context, reference is made to the European application 1 674 495 A1, the contents of which are incorporated by reference in this application.

The amine may be used alone or as a mixture of two or more thereof.

In one preferred specific embodiment, the resin component contains additional low-viscosity, radically polymerizable compounds or additional low-viscosity epoxy compounds as reactive diluents, in order, if necessary, to adjust the viscosity of the resin component.

Suitable reactive diluents for resins based on radically hardenable compounds are described in the applications EP 1 935 860 A1 and DE 195 31 649 A1. The resin mixture preferably contains as a reactive diluent, a (meth)acrylic acid ester, (meth)acrylic acid ester being particularly preferably selected from the group consisting of hydroxypropyl(meth)acrylate, propanediol-1,3-di(meth)acrylate, butanediol-1,2-di(meth)acrylate, trimethylolpropanetri(meth)acrylate, 2-ethylhexyl(meth)acrylate, phenylethyl(meth)acrylate, tetrahydrofurfuryl(meth)acrylate, ethyltriglycol(meth)acrylate, N,N-diemthylaminoethyl(meth)acrylate, N,N-diemthylaminomethyl(meth)acrylate, butanediol-1,4-di(meth)acrylate, acetoacetoxyethyl(meth)acrylate, ethanediol-1, 2-di(meth)acrylate, isobornyl(meth)acrylate, diethyleneglycoldi(meth)acrylate, methoxypolyethyleneglycolmono(meth)acrylate, trimethylcyclohexyl(meth)acrylate, 2-hydroxyethyl(meth)acrylate, dicyclopentenyloxyethyl(meth)acrylate and/or tricyclopentadienyldi(meth)acrylate, bisphenol-A-(meth)acrylate, novolakepoxy(meth)acrylate, di[(meth]acryloyl-maleoyl]-tricyclo-5.2.1.0.^{2,6}-decane, dicyclopentenyloxyethylcrotonate, 3-(meth)acryoyl-oxymethyl-tricyclo-5.2.1.0.^{2,6}-decane, 3-(meth)cyclopentadienyl(meth)acrylate, isobornyl(meth)acrylate and decalyl-2-(meth)acrylate.

In principle, other conventional radically polymerizable compounds may be used alone or mixed with the (meth)acrylic acid esters, for example, styrene, α-methylstyrene, alkylized styrene, such as tert-butyl styrene, divinylbenzene and allyl compounds.

Reactive diluents used for the epoxy-based resin component are glycidyl ethers of aliphatic, alicyclic or aromatic monoalcohols or, in particular, polyalcohols, such as monogylcidyl ethers, for example, o-cresyl glycidyl ether, and/or, in particular, glycidyl ether having an epoxy functionality of less than 2, such as 1,4-butanediol diglycidyl ether (BDDGE), cyclohexanedimethanol diglycidyl ether, hexane diolglycidyl ether and/or, in particular, tri glycidyl ethers or higher glycidyl ethers, for example, trimethylolpropane triglycidyl ether (TMPTGE), or additional mixtures of two or more of these reactive diluents, preferably triglycidyl ether, particularly preferably as a mixture of 1,4-butanediol diglycidyl ether (BDDGE) and trimethylolpropane triglycidyl ether (TMPTGE).

The peroxides are preferably initiated by an accelerator. Suitable accelerators known to those skilled in the art are advantageously amines.

The inhibitors normally used for radically polymerizable compounds, as they are known to those skilled in the art, are suitable as inhibitors, both for the storage stability of the radically hardenable compound and, therefore, of the resin component based on radically hardenable compounds, as well as for adjusting the gel time thereof. The inhibitors are preferably selected from among phenolic compounds and non-phenolic compounds such as stable radicals and/or phenothiazines.

Phenolic inhibitors, which are frequently a component of commercial radically hardenable reaction resins, include phenols, such as 2-methoxyphenol, 4-methoxyphenol, 2,6-di-tert-4-butyl-methylphenol, 2,4-di-tert-butylphenol, 2,6-di-tert-butylphenol, 2,4,6-trimethylphenol, 2,4,6-tris(dimethylaminomethyl)phenol, 4,4′-thio-bis(3-methyl-6-tert-butylphenol), 4,4′-isopropylidenediphenol, 6,6′-di-tert-butyl-4,4′-bis(2,6-di-tert-butylphenol), 1,3,5-trimethyl-2,4,6-tris(3,5-di-tert-butyl-4-hydroxybenzyl)benzyl, 2,2′methylene-di-p-cresol, pyrocatechols and butyl pyrocatechols, such as 4-tert-butyl pyrocatechol, 4,6-di-tert-butyl pyrocatechol, hydroquinones, such as hydroquinone, 2-methylhydroquinone, 2-tert-butylhydroquinone, 2,5-di-tert-butylhydroquinone, 2,6-di-tert-butylhydroquinone, 2,6-dimethylhydroquinone, 2,3,5-trimethylhydroquinone, benzoquinone, 2,3,5,6-tetrachloro-1,4-benzoquinone, methylbenzoquinone, 2,6-dimethylbenzoquinone, napthoquinone, or mixtures of two or more thereof.

Non-phenolic or anaerobic inhibitors, i.e., inhibitors effective even without oxygen, in contrast to the phenolic inhibitors, preferably include phenothiazines, such as phenothiazine and/or derivatives or combinations thereof, or stable organic radicals, such as galvinoxyl- and N-oxyl radicals.

N-oxylradicals, as these are described, for example, in DE 199 56 509, may be used. Suitable stable N-oxy-radicals (nitroxyl radicals) may be selected from among 1-oxyl-2,2,6,6-tetramethylpiperdine, 1-oxyl-2,2,6,6-tetramethylpiperdine-4-ol (also referred to as TEMPOL), 1-oxyl-2,2,6,6-tetramethylpiperdine-4-on (also referred to as TEMPON), 1-oxyl-2,2,6,6-tetramethyl-4-carboxyl-piperdine (also referred to as 4-carboxy-TEMPO), 1-oxyl-2,2,5,5-tetramethylpyrrolidine, 1-oxyl-2,2,5,5-tetramethyl-3-carboxylpyrrolidine (also referred to as 3-carboxy-PROXYL), aluminum-N-nitrosophenylhydroxylamine, diethylhydroxylamine. Additional suitable N-oxyl compounds are oximes, such as acetaldoxime, acetone oxime, methylethylketo oxime, salicyloxime, benzoxime, glyoximes, dimethylglyoxime, aceton-O-(benzyloxycarbonyl)oxime, or pyrimidinol compounds or pyridinol compounds substituted in para-position for the hydroxyl group, as they are described in the patent specification application DE 10 2011 077 248 B1, and the like.

The inhibitors may be used either alone or as a combination of two or more thereof, depending on the desired properties of the resin compositions. The combination of the phenolic and the non-phenolic inhibitors in this case allows for a synergistic effect, as is also shown by the adjustment of an essentially drift-free gel time of the reaction resin formula.

The resin component and/or the hardener component may also contain inorganic supplements, such as fillers and/or additional additives.

The fillers used are conventional fillers, preferably mineral or mineral-like fillers, such as quartz, glass, sand, quartz sand, quartz powder, porcelain, corundum, ceramic, talcum, silicic acid (for example, pyrogenic silicic acid), silicates, clay, titanium dioxide, chalk, heavy spar, feldspar, basalt, aluminum hydroxide, granite or sandstone, polymeric fillers, such as duroplasts, hydraulically hardenable fillers, such as plaster, quicklime or cement (for example, aluminate cement or Portland cement), metals, such as aluminum, carbon black, also wood, mineral or organic fibers, or the like, or mixtures of two or more thereof, which may be added as a powder in granular form or in the form of molds. The fillers may be present in arbitrary forms, for example, as a powder or flour, or as molds, for example, in the shape of a cylinder, ring, ball, plate, rod, saddle or crystal, or also in the form of fiber (fibrillary fillers) and the corresponding base particles preferably have a maximum diameter of 10 mm. However, the globular, inert substances (ball-shaped) have a preferable and significantly greater reinforcing effect.

Additional conceivable additives further include thixotropic agents such as, optionally, organic post-treated pyrogenic silicic acids, bentonites, alkylcelluloses and methylcelluloses, castor oil derivatives or the like, softening agents, such as phthalic acid ester or sebacic acid ester, stabilizers, antistatic agents, thickening agents, flexibilizers, hardening catalysts, rheology additives, wetting agents, color additives, such as dyes or, in particular, pigments, for example, for variously staining the components for better control of their blending, or the like, or mixtures of two or more thereof. Non-reactive thinning agents (solvents) may also be present, such as lower alkyl ketones, for example, acetone, di-lower-alkyl-lower-alkanoyl amides, such as dimethylacetamide, low-alkyl benzenes, such as xyloles or toluolene, phthalic acid esters or parafins, water or glycols.

Reference is made in this regard to the applications WO 02/079341 and WO 02/079293, the contents of which are incorporated by reference in this application.

In a particularly preferred specific embodiment, the resin component based on radically hardenable compounds, in addition to the radically hardenable compound, also contains a hydraulic-setting or polycondensatable inorganic compound, in particular, cement and the component (B), in addition to the hardening agent for the radically hardenable compound, also water. Such hybrid mortar systems are described in detail in DE 42 31 161 A1. In this embodiment, the component (A) preferably contains cement as the hydraulic-setting or polycondensatable inorganic compound, for example, Portland cement or aluminate cement, iron oxide-free or low iron oxide cements being particularly preferred. Plaster as such or mixed with cement may be used as the hydraulic-setting inorganic compound. The polycondensatable inorganic compound also includes siliceous, polycondensatable compounds, in particular substances containing soluble, dissolved and/or amorphous silicon dioxide.

The resin components and/or hardener components are used primarily for chemically fixing anchoring elements, such as anchors, reinforcement bars, screws and the like, in drill holes, in particular in drill holes in various mineral subsurfaces, such as those based on concrete, porous concrete, brick work, lime sandstone, natural stone and the like.

The following examples serve to explain the present invention in further detail.

### EXEMPLARY EMBODIMENTS

To determine the storage stability of the hardener component for a hybrid binder system, including a resin component, which contains radically hardenable methacrylate compounds and epoxy compounds according to EP 2357162 A1, a mortar mass has been manufactured in each case with the components described below and the curing behavior after different storage periods has been investigated with the aid of calorimetric differential scanning calorimetry (DSC).

### Examples 1 Through 3

### Hardener Component

To manufacture the hardening component, 48 g (38.5% by weight) of 2-methyl-1,5-pentandiamine (DYTEK® A, INVISTA (Deutschland) GmbH), 8 g (6.4% by weight) of tert-butylperoxybenzoate (Trigonox® C, Akzo Nobel Polymer Chemicals by), 56 g quartz powder (Millisil® W12 (technical), Quarzwerke GmbH; metal compounds contained: 0.3% Al₂O₃, 0.05 Fe₂O₃, 0.1% CaO and MgO, 0.2% Na₂O and K₂O) and 11.2 g (9% by weight) of a hydrophobic pyrogenic silicic acid and, in each case, 1.4 g (1.1% by weight) of the surface-functionalized silicic acids shown in Table 1 are pre-mixed using a wooden spatula and subsequently dispersed in a planet dissolver of PC Laborsystem at 3500 rev/min at 80 mbar for 10 minutes, a homogenous mass being obtained.

Resin Component

The resin component manufactured was a resin component according to Example 1 of EP 2357162 A1.

TABLE 1
surface-functionalized silicic acids used

| Example | Ligand |
|---|---|
| 1 ^{a)} | 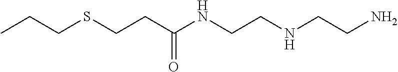 |
| 2 ^{b)} | 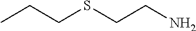 |
| 3 ^{c)} | 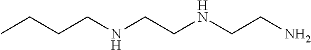 |

^{a)} STA3, PhosphonicsS Ltd
^{b)} SEA, PhosphonicS Ltd
^{c)} PhsophonicS Ltd

### Comparison Example 1

A hardener component is used as a comparison, which has been manufactured similarly to the Examples 1 through 3, with the difference that no surface-functionalized silicic acid has been admixed as a metal separator. The resin component corresponds to the component from the Examples 1 through 3.

Determination of Storage Stability

To determine the storage stability, the hardener components have been stored at +40° C. according to the timetable as seen in Table 2. After storage, the hardener components have been mixed in each case with a resin component freshly manufactured and stored for one day at +40° C. in a volume ratio (v/v) resin component:hardener component of approximately 5:1 to form a mortar mass. The storage stability was assessed based on the temperature curves of the curing.

TABLE 2
Storage times of the resin and hardener components

| | Storage time [days] | | | |
|---|---|---|---|---|
| Resin component | 1 | 1 | 1 | 1 |
| Hardener component | 1 | 70 | 91 | 154 |

TABLE 3
Results of the isothermic dynamic differential
scanning calorimetry at +40° C.

| | | Peak temperature | Time until |
|---|---|---|---|
| | Storage period | (=maximum | maximum curing |
| | hardener component | curing rate) | rate achieved |
| Example | [days] | [° C.] | [min] |
| 1 | 1 | 137 | 14 |
| | 70 | 132 | 8 |
| | 91 | 140 | 7 |
| | 154 | 63 | — *) |
| 2 | 1 | 142 | 13 |
| | 70 | 140 | 9 |
| | 91 | 131 | 7 |
| | 154 | 51 | — *) |
| 3 | 1 | 140 | 13 |
| | 70 | 144 | 8 |
| | 91 | 133 | 7 |
| | 154 | 113 | 9 |
| Comparison | 1 | 118 | 11 |
| | 14 | 140 | 10 |
| | 42 | 126 | 9 |
| | 91 | 48 | — *) |
| | 154 | (48) | — *) |

*) no notable cross-linking occured

It is apparent from Table 3 that all samples, in which the hardener component has been stored for only one day, show a comparable curing.

The comparison composition ceased curing after a storage period of 91 days (13 weeks). This is due to the fact that the hardener, in particular, the peroxide, as a result of the metal compounds present, becomes inactivated to such an extent that a reaction at least of the radically hardenable compound no longer occurs.

Conversely, during storage beyond the same time period, no or virtually no inactivation of the peroxide compound was observed in the case of hardener components, to which a metal separator has been added according to the present invention. The peak temperature in all of the examples is comparable to the fresh composition (storage of hardener component: 1 day). Only in the case of storage at +40° C. over 154 days (22 weeks) do the mortar masses having the hardener components of Examples 1 and 2 cease to cure, corresponding to an inactivation of the peroxide compound. However, the mortar mass manufactured with the hardener component from Example 3 shows no inactivation of the peroxide compound, which is recognizable by the continued high peak temperature and the time needed to reach the peak temperature.

Thus, it could be demonstrated that by adding a surface-functionalized silicic acid, which bears on its surface organic polydentate ligands, which may form a chelate complex with metals or metal compounds, to a hardener component containing metal-bearing fillers, as an additive, it was possible to significantly increase the storage stability as compared to a corresponding hardener component without this additive. The corresponding mortar masses also cured completely after storage over 13 weeks at +40° C.

1-18. (canceled)

19: A resin component based on radically hardenable compounds and/or based on epoxy, the resin component comprising, as an additive:
a surface-functionalized silicic acid bearing on its surface organic polydentate ligands, and capable of forming a chelate complex with metals or metal compounds.

20: The resin component as recited in claim 19 wherein the surface-functionalized silicic acid is a compound of the general formula (I)
[O_{4/2}Si]ₐ[O_{3/2}SiCH₂(CR³R⁴)ₘX]_{b}[O_{3/2}SiCH₂(CR³R⁴)ₙY]_{c}[O_{3/2}SiV]_{d} (I),
in which X is selected from among NRR², NR[(CH₂)ₚNR¹]ᵢR², SR, S(CH₂)ₑSR, S(CH₂)_{f}U, S[(CH₂)ⱼS]ₜR, S[(CH₂)ₑS]ₜ(CH₂)ₛZ, NRC(S)NR¹H, SCH₂CH(NHR)CO₂E, SCH₂CH(CO₂E)CH₂CO₂E, S(CH₂)ₗOR, S(CH₂)ᵤC(O)W, S(CH₂)ⱼNRC(S)NR¹H and OCH₂CH(OH)CH₂NR[(CH₂)ₚNR¹]ᵢR³, in which U represents a heteroaromatic ring, Z represents SiO_{3/2} or a heteroaromatic ring, E represents hydrogen, C₁-C₁₀-alkyl or a metal ion M, and W represents OH, OR, OM or NR[(CH₂)ₚNR¹]ᵢR²;
Y is selected from among NRR², NR[(CH₂)ₚNR¹]ᵢR², SR, S(CH₂)ₑSR, S(CH₂)_{f}U, S[(CH₂)ⱼS]ₜR or S[(CH₂)ₑS]ₜ(CH₂)ₛZ;
R, R¹, R³ and R⁴ are independently selected from among hydrogen, C₁-C₂₂-alkyl, C₁-C₂₂-aryl and C₁-C₂₂-alkylaryl; R² is selected from among hydrogen, C₁-C₂₂-alkyl or C₂-C₁₀-alkyl-Si(O)_{3/2};
l, s, t and u represent independently whole numbers from 1 through 100;
i represents a whole number from 1 through 10,000;
m and n represent independently a whole number from 1 through 100; and
e, f, j and p represent independently a whole number from 2 through 20;
V represents an optionally substituted group, which is selected from among C₁-C₂₂-alkyl, C₂-C₂₂-alkenyl, C₂-C₂₂-alkinyl, aryl, C₁-C₂₂-alkylaryl, C₁-C₂₂-alkyl, which is substituted by a sulfide, sulfoxide, sulfone, amine, polyalkylamine, phosphine or other phosphorous-containing groups, or contains these groups as part of the hydrocarbon chain;
the free valences of the oxygen atoms of the silicate are saturated by
one or multiple groups, which are selected from among a silicon atom of other compounds of the general formula (I), hydrogen, a linear or branched C₁-C₂₂-alkyl group, an end group R⁵₃M¹O_{1/2}, a cross-linking bridge member or a chain R⁵_{q}M¹(OR⁶)_{g}O_{k/2} or Al(OR⁶)₃₋ₕO_{h/2} or R⁵Al(OR⁶)₂₋ᵣO_{r/2}, in which M¹ represents Si or Ti; R⁵ and R⁶ being independently selected from among a linear or branched C₁-C₂₂-alkyl group, aryl group and C₁-C₂₂-alkylaryl group; k represents a whole number from 1 through 3, q represents 1 or 2 and g represents a whole number from 0 through 2, g+k+q being 4, h representing a whole number from 1 through 3 and r representing 1 or 2; or an oxometal binding system, the metal being zirconium, boron, magnesium, iron, nickel or a lanthanide;
a, b, c and d represent whole numbers, so that the ratio b:a is between 0.00001 and 100,000, and
a and b are always greater than 0, and if c is greater than 0, the ratio c:a+b is between 0.00001 and 100,000, and if d is greater than zero, the ratio d:a+b is between 0.00001 and 100,000; if an end group and/or a cross-linking agent or a polymer chain is/are used, the ratio of the end group, of the cross-linking agent or of the polymer chain to a+b+c+d is between 0 and 999:1.

21: The resin component as recited in claim 20 wherein the surface-functionalized silicic acid is a compound of the general formula (I), in which
X is selected from among NRR², NR[(CH₂)ₚNR¹]ᵢR², SR, S(CH₂)ₑSR, S[(CH₂)ᵢS]ₜR, S[(CH₂)ₑS]ₜ(CH₂)ₛZ, NRC(S)NR¹H, S(CH₂)ᵤC(O)W, S(CH₂)NRC(S)NR¹H and OCH₂CH(OH)CH₂NR[(CH₂)ₚNR¹]ᵢR^{3′} in which Z represents SiO_{3/2} or a heteroaromatic ring, and W represents NR[(CH₂)ₚNR¹]ᵢR²;
and if c is greater than 0, Y is selected from among NRR², NR[(CH₂)ₚNR¹]ᵢR², SR, S(CH₂)ₑSR, S[(CH₂)ⱼS]ₜR or S[(CH₂)ₑS]ₜ(CH₂)ₛZ;
R and R¹ are independently selected from among hydrogen, C₁-C₁₀-alkyl, C₁-C₂₂-aryl and C₁-C₂₂-alkylaryl; R² is selected from among hydrogen, C₁-C₂₂-akyl or C₂-C₁₀-alkyl-Si(O)_{3/2}; R³ and R⁴ represent hydrogen;
s, t and u represent independently whole numbers from 1 through 20;
i represents a whole number from 1 through 10,000;
m and n represent independently whole numbers from 1 through 10; and
e, j and p represent independently whole numbers from 2 through 20;
V represents an optionally substituted group, which is selected from among C₁-C₂₂-akyl, C₂-C₂₂-alkenyl, C₂-C₂₂-alkinyl, aryl, C₁-C₂₂-alkylaryl, C₁-C₂₂-akyl, which is substituted by a sulfide, a sulfoxide, a sulfone, an amine or a polyalkylamine, or contains these groups as part of the hydrocarbon chain;
the free valences of the oxygen atoms of the silicate are saturated by
one or multiple groups, which are selected from among a silicon atom of one of the other compounds of the general formula (I), hydrogen, a linear or branched C₁-C₁₂-alkyl group and an end group R⁵₃SiO_{1/2}, a cross-linking bridge member or a chain R⁵_{q}Si(OR⁶)₉O_{k/2} or Al(OR⁶)₃₋ₕO_{h/2} or R⁵Al(OR⁶)₂₋ᵣO_{r/2}, in which R⁵ and R⁶ are independently selected from among a linear or branched C₁-C₆-akyl group, aryl group and C₁-C₂₂-alkylaryl group.
a, b, c and d represent whole numbers, so that the ratio b:a is between 0.00001 and 100, and a and b are always greater than 0, and if c is greater than 0, the ratio c:a+b is between 0.00001 and 100, and if d is greater than zero, the ratio of d:a+b is between 0.00001 and 100; if an end group and/or a cross-linking agent or a polymer chain is/are used, the ratio of the end group, the cross-linking agent or the polymer chains to a+b+c+d is between 0 and 999:1.

22: The resin component as recited in claim 21 wherein the surface-functionalized silicic acid is a compound of the general formula (I), in which
X is selected from among NRR², NH[(CH₂)ₚNH]ᵢR², SR, S(CH₂)ₑSH, S[(CH₂)ᵢS]ₜH, S[(CH₂)ₑS]ₜ(CH₂)ₛZ, NHC(S)NR¹H, S(CH₂)ᵤC(O)W, S(CH₂)NRC(S)NR¹H and OCH₂CH(OH)CH₂NH[(CH₂)ₚNH]ᵢH′ in which Z represents SiO_{3/2}, or a heteroaromatic ring, and W represents NH[(CH₂)ₚNH]ᵢH;
and if c is greater than 0, Y is selected from among NRR¹, NH[(CH₂)ₚNH]ᵢRH, SR, S(CH₂)ₑSH, S[(CH₂)ⱼS]ₜH or S[(CH₂)ₑS]ₜ(CH₂)ₛZ;
R and R¹ are independently selected from among hydrogen, C₁-C₁₀-alkyl, C₁-C₂₂-aryl and C₁-C₂₂-alkylaryl; R² is selected from among hydrogen, C₁-C₂₂-akyl or C₃-alkyl-Si(O)_{3/2}; R³ and R⁴ represent hydrogen;
s, t and u represent independently whole numbers from 1 through 10;
i represents a whole number from 1 through 10,000;
m and n represent independently whole numbers from 1 through 5; and
e, j, s and p represent independently whole numbers from 2 through 10;
V represents an optionally substituted group, which is selected from among C₁-C₁₂-akyl, C₂-C₂₂-alkenyl, C₂-C₂₂-alkinyl, aryl, C₁-C₂₂-akyl, which is substituted by a sulfide or an amine or contains these groups as part of the hydrocarbon chain;
the free valences of the oxygen atoms of the silicate are saturated by
one or multiple groups, which are selected from among a silicon atom of one of the other compounds of the general formula (I), hydrogen, a linear or branched C₁-C₁₂-alkyl group and an end group R⁵₃SiO_{1/2}, a cross-linking bridge member or a chain R⁵_{q}Si(OR⁶)_{g}O_{k/2} or Al(OR⁶)₃₋ₕO_{h/2} or R⁵Al(OR⁶)₂₋ᵣO_{r/2}, in which R⁵ and R⁶ are independently selected from among a linear or branched C₁-C₆-akyl group, an aryl group and a C₁-C₂₂-alkylaryl group.
a, b, c and d represent whole numbers, so that the ratio b:a is between 0.00001 and 10, and a and b are always greater than 0, and if c is greater than 0, the ratio c:a+b is between 0.00001 and 10, and if d is greater than zero, the ratio of d:a+b is between 0.00001 and 10; if an end group and/or a cross-linking agent or a polymer chain is/are used, the ratio of the end group, the cross-linking agent or the polymer chains to a+b+c+d is between 0 and 99:1.

23: The resin component as recited in claim 22 wherein the surface-functionalized silicic acid is a compound of the general formula (I), in which
X is selected from among NR[(CH₂)ₚNR¹]ᵢR², S(CH²)ₑSH, S(CH₂)ᵤC(O)W, S(CH₂)ⱼNRC(S)NR¹H, in which W represents NH[(CH₂)ₚNH]ᵢH;
c and d are 0;
R and R¹ are independently selected from among hydrogen or C₁-alkyl; R² represents hydrogen;
R³ and R⁴ represent hydrogen;
u and i independently represent 1 or 2;
e, j and p independently represent 2 or 3;
the free valences of the oxygen atoms of the silicate are saturated by
one or multiple groups, which are selected from among a silicon atom of one of the other compounds of the general formula (I), hydrogen, a linear or branched C₁-C₁₂-alkyl group and an end group R⁵₃SiO_{1/2}, a cross-linking bridge member or a chain R⁵_{q}Si(OR⁶)_{g}O_{k/2} or Al(OR⁶)₃₋ₕO_{h/2} or R⁵Al(OR⁶)₂₋ᵣO_{r/2}, in which R⁵ and R⁶ are independently selected from among a linear or branched C₁-C₆-akyl group, an aryl group and a C₁-C₂₂-alkylaryl group; a and b represent whole numbers, so that the ratio b:a is between 0.00001 and 10.

24: The resin component as recited in claim 19 wherein the surface-functionalized silicic acid is a surface-functionalized, pyrogenically manufactured silicic acid.

25: A peroxide-based and/or amine-based hardener component, comprising, as an additive:
a surface-functionalized silicic acid bearing on its surface organic polydentate ligands, and capable of forming a chelate complex with the metals or metal compounds.

26: The hardener component as recited in claim 25 wherein the surface-functionalizing silicic is a compound of the general formula (I)
[O_{4/2}Si]ₐ[O_{3/2}SiCH₂(CR³R⁴)ₘX]_{b}[O_{3/2}SiCH₂(CR³R⁴)ₙY]_{c}[O_{3/2}SiV]_{d} (I),
in which X is selected from among NRR², NR[(CH₂)ₚNR¹]ᵢR², SR, S(CH₂)ₑSR, S(CH₂)_{f}U, S[(CH₂)ⱼS]ₜR, S[(CH₂)ₑS]ₜ(CH₂)ₛZ, NRC(S)NR¹H, SCH₂CH(NHR)CO₂E, SCH₂CH(CO₂E)CH₂CO₂E, S(CH₂)ᵢOR, S(CH₂)ᵤC(O)W, S(CH₂)ⱼNRC(S)NR¹H and OCH₂CH(OH)CH₂NR[(CH₂)ₚNR¹]ᵢR³, in which U represents a heteroaromatic ring, Z represents SiO_{3/2} or a heteroaromatic ring, E represents hydrogen, C₁-C₁₀-alkyl or a metal ion M, and W represents OH, OR, OM or NR[(CH₂)ₚNR¹]ᵢR²;
Y is selected from among NRR², NR[(CH₂)ₚNR¹]ᵢR², SR, S(CH₂)ₑSR, S(CH₂)_{f}U, S[(CH₂)ⱼS]ₜR or S[(CH₂)ₑS]ₜ(CH₂)ₛZ;
R, R¹, R³ and R⁴ are independently selected from among hydrogen, C₁-C₂₂-alkyl, C₁-C₂₂-aryl and C₁-C₂₂-alkylaryl; R² is selected from among hydrogen, C₁-C₂₂-alkyl or C₂-C₁₀-alkyl-Si(O)_{3/2};
l, s, t and u represent independently whole numbers from 1 through 100;
i represents a whole number from 1 through 10,000;
m and n represent independently whole numbers from 1 through 100; and
e, f, j and p represent independently whole numbers from 2 through 20;
V represents an optionally substituted group, which is selected from among C₁-C₂₂-alkyl, C₂-C₂₂-alkenyl, C₂-C₂₂-alkinyl, aryl, C₁-C₂₂-alkylaryl, C₁-C₂₂-alkyl, which is substituted by a sulfide, sulfoxide, sulfone, amine, polyalkylamine, phosphine or other phosphorous-containing groups, or contains these groups as part of the hydrocarbon chain;
the free valences of the oxygen atoms of the silicate are saturated by
one or multiple groups, which are selected from among a silicon atom of other compounds of the general formula (I), hydrogen, a linear or branched C₁-C₂₂-alkyl group, an end group R⁵₃M¹O_{1/2}, a cross-linking bridge member or a chain R⁵_{q}M¹(OR⁶)_{g}O_{k/2} or Al(OR⁶)₃₋ₕO_{h/2} or R⁵Al(OR⁶)₂₋ᵣO_{r/2}, in which M¹ represents Si or Ti; R⁵ and R⁶ are independently selected from among a linear or branched C₁-C₂₂-alkyl group, an aryl group and a C₁-C₂₂-alkylaryl group, k represents a whole number from 1 through 3, q represents 1 or 2 and g represents a whole number from 0 through 2, g+k+q=4, h represents a whole number from 1 through 3 and r represents 1 or 2; or an oxometal binding system, the metal being zirconium, boron, magnesium, iron, nickel or a lanthanide;
a, b, c and d represent whole numbers, so that the ratio b:a is between 0.00001 and 100,000, and a and b are always greater than 0, and if c is greater than 0, the ratio c:a+b is between 0.00001 and 100,000, and if d is greater than zero, the ratio d:a+b is between 0.00001 and 100,000; if an end group and/or a cross-linking agent or a polymer chain is/are used, the ratio of the end group, of the cross-linking agent or of the polymer chains to a+b+c+d is between 0 and 999:1.

27: The hardener component as recited in claim 26 wherein the surface-functionalized silicic acid is a compound of the general formula (I), in which
X is selected from among NRR², NR[(CH₂)ₚNR¹]ᵢR², SR, S(CH₂)ₑSR, S[(CH₂)ᵢS]ₜR, S[(CH₂)ₑS]ₜ(CH₂)ₛZ, NRC(S)NR¹H, S(CH₂)ᵤC(O)W, S(CH₂)NRC(S)NR¹H and OCH₂CH(OH)CH₂NR[(CH₂)ₚNR¹]ᵢR³, in which Z represents SiO_{3/2} or a heteroaromatic ring, and W represents NR[(CH₂)ₚNR¹]ᵢR²;
and if c is greater than 0, Y is selected from among NRR², NR[(CH₂)ₚNR¹]ᵢR², SR, S(CH₂)ₑSR, S[(CH₂)ⱼS]ₜR or S[(CH₂)ₑS]ₜ(CH₂)ₛZ;
R and R¹ are independently selected from among hydrogen, C₁-C₁₀-alkyl, C₁-C₂₂-aryl and C₁-C₂₂-alkylaryl; R² is selected from among hydrogen, C₁-C₂₂-alkyl or C₂-C₁₀-alkyl-Si(O)_{3/2}; R₃ and R₄ represent hydrogen;
s, t and u represent independently whole numbers from 1 through 20;
i represents a whole number from 1 through 10,000;
m and n represent independently whole numbers from 1 through 10; and
e, j and p represent independently whole numbers from 2 through 20;
V represents an optionally substituted group, which is selected from among C₁-C₂₂-alkyl, C₂-C₂₂-alkenyl, C₂-C₂₂-alkinyl, aryl, C₁-C₂₂-alkylaryl, C₁-C₂₂-alkyl, which is substituted by a sulfide, sulfoxide, sulfone, amine, polyalkylamine, or contains these groups as part of the hydrocarbon chain;
the free valences of the oxygen atoms of the silicate are saturated by
one or multiple groups, which are selected from among a silicon atom of one of the other compounds of the general formula (I), hydrogen, a linear or branched C₁-C₁₂-alkyl group, an end group R⁵₃SiO_{1/2}, a cross-linking bridge member or a chain R⁵_{q}Si(OR⁶)_{g}O_{k/2} or Al(OR⁶)₃₋ₕO_{h/2} or R⁵Al(OR⁶)₂₋ᵣO_{r/2}, in which R⁵ and R⁶ are independently selected from among a linear or branched C₁-C₆-alkyl group, an aryl group and a C₁-C₂₂-alkylaryl group;
a, b, c and d represent whole numbers, so that the ratio b:a is between 0.00001 and 100, and a and b are always greater than 0, and if c is greater than 0, the ratio c:a+b is between 0.00001 and 100, and if d is greater than zero, the ratio d:a+b is between 0.00001 and 100; if an end group and/or a cross-linking agent or a polymer chain is/are used, the ratio of the end group, of the cross-linking agent or of the polymer chains to a+b+c+d is between 0 and 999:1

28: The hardener component as recited in claim 27 wherein the surface-functionalized silicic acid is a compound of the general formula (I), in which
X is selected from among NRR², NR[(CH₂)ₚNH¹]ᵢR², SR, S(CH₂)ₑSH, S[(CH₂)ᵢS]ₜH, S[(CH₂)ₑS]ₜ(CH₂)ₛZ, NHC(S)NR¹H, S(CH₂)ᵤC(O)W, S(CH₂)NRC(S)NR¹H and OCH₂CH(OH)CH₂NH[(CH₂)ₚNH¹]ᵢH, in which Z represents SiO_{3/2} or a heteroaromatic ring, and W represents NH[(CH₂)ₚNH]ᵢH;
and if c is greater than 0, Y is selected from among NRR¹, NR[(CH₂)ₚNH]ᵢRH, SR, S(CH₂)ₑSH, S[(CH₂)ⱼS]ₜH or S[(CH₂)ₑS]ₜ(CH₂)ₛZ;
R and R¹ are independently selected from among hydrogen, C₁-C₁₀-alkyl, C₁-C₂₂-aryl and C₁-C₂₂-alkylaryl; R² is selected from among hydrogen, C₁-C₂₂-alkyl or C₃-alkyl-Si(O)_{3/2}; R₃ and R₄ represent hydrogen;
s, t and u represent independently whole numbers from 1 through 10;
i represents a whole number from 1 through 10,000;
m and n represent independently whole numbers from 1 through 5; and
e, j, s and p represent independently whole numbers from 2 through 10;
V represents an optionally substituted group, which is selected from among C₁-C₁₂-alkyl, C₂-C₂₂-alkenyl, C₂-C₂₂-alkinyl, aryl, C₁-C₂₂-alkylaryl, which is substituted by a sulfide or amine or contains these groups as part of the hydrocarbon chain;
the free valences of the oxygen atoms of the silicate are saturated by
one or multiple groups, which are selected from among a silicon atom of one of the other compounds of the general formula (I), hydrogen, a linear or branched C₁-C₁₂-alkyl group, an end group R⁵₃SiO_{1/2}, a cross-linking bridge member or a chain R⁵_{q}Si(OR⁶)_{g}O_{k/2} or Al(OR⁶)₃₋ₕO_{h/2} or R⁵Al(OR⁶)₂₋ᵣO_{r/2}, in which R⁵ and R⁶ are independently selected from among a linear or branched C₁-C₆-alkyl group, an aryl group and a C₁-C₂₂-alkylaryl group;
a, b, c and d represent whole numbers, so that the ratio b:a is between 0.00001 and 10, and a and b are always greater than 0, and if c is greater than 0, the ratio c:a+b is between 0.00001 and 10, and if d is greater than zero, the ratio d:a+b is between 0.00001 and 10; if an end group and/or a cross-linking agent or a polymer chain is/are used, the ratio of the end group, of the cross-linking agent or of the polymer chains to a+b+c+d is between 0 and 99:1.

29: The hardener component as recited in claim 28 wherein the surface-functionalized silicic acid is a compound of the general formula (I), in which
X is selected from among NR[(CH₂)ₚNR¹]ᵢR², S(CH₂)ₑSH, S(CH₂)ᵤC(O)W, S(CH₂)ⱼNRC(S)NR¹H, in which W represents NH[(CH₂)ₚNH]ᵢH;
c and d are 0;
R and R¹ are independently selected from among hydrogen or C₁-alkyl; R² represents hydrogen;
R₃ and R₄ represent hydrogen;
u and i represent independently 1 or 2;
e, j and p represent independently 2 or 3;
the free valences of the oxygen atoms of the silicate are saturated by
one or multiple groups, which are selected from among a silicon atom of one of the other compounds of the general formula (I), hydrogen, a linear or branched C₁-C₁₂-alkyl group and an end group R⁵₃SiO_{1/2}, a cross-linking bridge member or a chain R⁵_{q}Si(OR⁶)_{g}O_{k/2} or Al(OR⁶)₃₋ₕO_{h/2} or R⁵Al(OR⁶)₂₋ᵣO_{r/2}, in which R⁵ and R⁶ are independently selected from among a linear or branched C₁-C₆-alkyl group, an aryl group and a C₁-C₂₂-alkylaryl group;
a, b, c and d represent whole numbers, so that the ratio b:a is between 0.00001 and 10.

30: The hardener component as recited in claim 25 wherein the surface-functionalized silicic acid is a surface-functionalized, pyrogenically manufactured silicic acid.

31: A method for use of a surface-functionalized silicic acid, the silicic acid bearing on its surface organic polydentate ligands, and capable of forming a chelate complex with metals or metal compounds, the method comprising:
adding the silicic acid as an additive for the resin component and/or hardener component of a multi-component reaction resin composition.

32: The method as recited in claim 31, wherein the surface-functionalized silicic acid is a compound of the general formula (I)
[O_{4/2}Si]ₐ[O_{3/2}SiCH₂(CR³R⁴)ₘX]_{b}[O_{3/2}SiCH₂(CR³R⁴)ₙY]_{c}[O_{3/2}SiV]_{d} (I),
in which X is selected from among NRR², NR[(CH₂)ₚNR¹]ᵢR², SR, S(CH₂)ₑSR, S(CH₂)_{f}U, S[(CH₂)ⱼS]ₜR, S[(CH₂)ₑS]ₜ(CH₂)ₛZ, NRC(S)NR¹H, SCH₂CH(NHR)CO₂E, SCH₂CH(CO₂E)CH₂CO₂E, S(CH₂)ₗOR, S(CH₂)ᵤC(O)W, S(CH₂)ⱼNRC(S)NR¹H and OCH₂CH(OH)CH₂NR[(CH₂)ₚNR¹]ᵢR³, in which U represents a heteroaromatic ring, Z represents SiO_{3/2} or a heteroaromatic ring, E represents hydrogen, C₁-C₁₀-alkyl or a metal ion M, and W represents OH, OR, OM or NR[(CH₂)ₚNR¹]ᵢR²;
Y is selected from among NRR², NR[(CH₂)ₚNR¹]ᵢR², SR, S(CH₂)ₑSR, S(CH₂)_{f}U, S[(CH₂)ⱼS]ₜR or S[(CH₂)ₑS]ₜ(CH₂)ₛZ;
R, R¹, R³ and R⁴ are independently selected from among hydrogen, C₁-C₂₂-alkyl, C₁-C₂₂-aryl and C₁-C₂₂-alkylaryl; R² is selected from among hydrogen, C₁-C₂₂-alkyl or C₂-C₁₀-alkyl-Si(O)_{3/2};
l, s, t and u represent independently whole numbers from 1 through 100;
i represents a whole number from 1 through 10,000;
m and n represent independently whole numbers from 1 through 100; and
e, f, j and p represent independently whole numbers from 2 through 20;
V represents an optionally substituted group, which is selected from among C₁-C₂₂-alkyl, C₂-C₂₂-alkenyl, C₂-C₂₂-alkinyl, aryl, C₁-C₂₂-alkylaryl, C₁-C₂₂-alkyl, which is substituted by a sulfide, sulfoxide, sulfone, amine, polyalkylamine, phosphine or other phosphorous-containing groups, or contains these groups as part of the hydrocarbon chain;
the free valences of the oxygen atoms of the silicate are saturated by
one or multiple groups, which are selected from among a silicon atom of other compounds of the general formula (I), hydrogen, a linear or branched C₁-C₂₂-alkyl group, an end group R⁵₃M¹O_{1/2}, a cross-linking bridge member or a chain R⁵_{q}M¹(OR⁶)_{g}O_{k/2} or Al(OR⁶)₃₋ₕO_{k/2} or R⁵Al(OR⁶)₂₋ᵣO_{r/2}, in which M¹ represents Si or Ti; R⁵ and R⁶ are independently selected from among a linear or branched C₁-C₂₂-alkyl group, aryl group and C₁-C₂₂-alkylaryl group; k represents a whole number from 1 through 3, q represents 1 or 2 and g represents a whole number from 0 through 2, g+k+q equaling 4, h representing a whole number from 1 through 3 and r representing 1 or 2; or an oxometal binding system, the metal being zirconium, boron, magnesium, iron, nickel or a lanthanide;
a, b, c and d represent whole numbers, so that the ratio b:a is between 0.00001 and 100,000, and a and b are always greater than 0, and if c is greater than 0, the ratio c:a+b is between 0.00001 and 100,000, and if d is greater than zero, the ratio d:a+b is between 0.00001 and 100,000; if an end group and/or a cross-linking agent or a polymer chain is/are used, the ratio of the end group, of the cross-linking agent or of the polymer chains to a+b+c+d is between 0 and 999:1.

33: The method as recited in claim 32 wherein the surface-functionalizing silicic acid is a compound of the general formula (I), in which
X is selected from among NRR², NR[(CH₂)ₚNR¹]ᵢR², SR, S(CH₂)ₑSR, S[(CH₂)ᵢS]ₜR, S[(CH₂)ₑS]ₜ(CH₂)ₛZ, NRC(S)NR¹H, S(CH₂)ᵤC(O)W, S(CH₂)NRC(S)NR¹H and OCH₂CH(OH)CH₂NR[(CH₂)ₚNR¹]ᵢR³, in which Z represents SiO_{3/2}, or a heteroaromatic ring and W represents NR[(CH₂)ₚNR¹]ᵢR²;
and if c is greater than 0, Y is selected from among NRR², NR[(CH₂)ₚNR¹]R², SR, S(CH₂)ₑSR, S[(CH₂)ⱼS]ₜR or S[(CH₂)ₑS]ₜ(CH₂)ₛZ;
R and R¹ are independently selected from among hydrogen, C₁-C₁₀-alkyl, C₁-C₂₂-aryl and C₁-C₂₂-alkylaryl; R² is selected from among hydrogen, C₁-C₂₂-alkyl or C₂-C₁₀-alkyl-Si(O)_{3/2}; R₃ and R₄ represent hydrogen;
s, t and u represent independently whole numbers from 1 through 20;
i represents a whole number from 1 through 10,000;
m and n represent independently whole numbers from 1 through 10; and
e, j and p represent independently whole numbers from 2 through 20;
V represents an optionally substituted group, which is selected from among C₁-C₂₂-alkyl, C₂-C₂₂-alkenyl, C₂-C₂₂-alkinyl, aryl, C₁-C₂₂-alkylaryl, C₁-C₂₂-alkyl, which is substituted by a sulfide, sulfoxide, sulfone, amine or a polyalkylamine, or contains these groups as part of the hydrocarbon chain;
the free valences of the oxygen atoms of the silicate are saturated by
one or multiple groups, which are selected from among a silicon atom of one of the other compounds of the general formula (I), hydrogen, a linear or branched C₁-C₁₂-alkyl group and an end group R⁵₃SiO_{1/2}, a cross-linking bridge member or a chain R⁵_{q}Si(OR⁶)_{g}O_{k/2} or Al(OR⁶)₃₋ₕO_{h/2} or R⁵Al(OR⁶)₂₋ᵣO_{r/2}, in which R⁵ and R⁶ are independently selected from among a linear or branched C₁-C₆-alkyl group, aryl group and C₁-C₂₂-alkylaryl group;
a, b, c and d represent whole numbers, so that the ratio b:a is between 0.00001 and 100, and a and b are always greater than 0, and if c is greater than 0, the ratio c:a+b is between 0.00001 and 100, and if d is greater than zero, the ratio d:a+b is between 0.00001 and 100; if an end group and/or a cross-linking agent or a polymer chain is/are used, the ratio of the end group, of the cross-linking agent or of the polymer chains to a+b+c+d is between 0 and 999:1.

34: The method as recited in claim 33 wherein the surface-functionalized silicic acid is a compound of the general formula (I), in which
X is selected from among NRR², NH[(CH₂)ₚNH]ᵢR², SR, S(CH₂)ₑSH, S[(CH₂)ᵢS]ₜH, S[(CH₂)ₑS]ₜ(CH₂)ₛZ, NHC(S)NR¹H, S(CH₂)ᵤC(O)W, S(CH₂)NRC(S)NR¹H and OCH₂CH(OH)CH₂NH[(CH₂)ₚNH]ᵢH, in which Z represents SiO_{3/2} or a heteroaromatic ring, and W represents NH[(CH₂)ₚNH]ᵢH;
and if c is greater than 0, Y is selected from among NRR², NH[(CH₂)ₚNH]ᵢRH, SR, S(CH₂)ₑSH, S[(CH₂)ⱼS]ₜH or S[(CH₂)ₑS]ₜ(CH₂)ₛZ;
R and R¹ are independently selected from among hydrogen, C₁-C₁₀-alkyl, C₁-C₂₂-aryl and C₁-C₂₂-alkylaryl; R² is selected from among hydrogen, C₁-C₂₂-alkyl or C₃-alkyl-Si(O)_{3/2}; R₃ and R₄ represent hydrogen;
s, t and u represent independently whole numbers from 1 through 10;
i represents a whole number from 1 through 10,000;
m and n represent independently whole numbers from 1 through 5; and
e, j, s and p represent independently whole numbers from 2 through 10;
V represents an optionally substituted group, which is selected from among C₁-C₁₂-alkyl, C₂-C₂₂-alkenyl, C₂-C₂₂-alkinyl, aryl, C₁-C₂₂-alkyl, which is substituted by a sulfide or an amine, or contains these groups as part of the hydrocarbon chain;
the free valences of the oxygen atoms of the silicate are saturated by one or multiple groups, which are selected from among a silicon atom of one of the other compounds of the general formula (I), hydrogen, a linear or branched C₁-C₁₂-alkyl group and an end group R⁵₃SiO_{1/2}, a cross-linking bridge member or a chain R⁵_{q}Si(OR⁶)_{g}O_{k/2} or Al(OR⁶)₃₋ₕO_{h/2} or R⁵Al(OR⁶)₂₋ᵣO_{r/2}, in which R⁵ and R⁶ are independently selected from among a linear or branched C₁-C₆-alkyl group, an aryl group and a C₁-C₂₂-alkylaryl group;
a, b, c and d represent whole numbers, so that the ratio b:a is between 0.00001 and 10, and a and b are always greater than 0, and if c is greater than 0, the ratio c:a+b is between 0.00001 and 10, and if d is greater than zero, the ratio d:a+b is between 0.00001 and 10; if an end group and/or a cross-linking agent or a polymer chain is/are used, the ratio of the end group, of the cross-linking agent or of the polymer chains to a+b+c+d is between 0 and 99:1.

35: The method as recited in claim 34 wherein the surface-functionalized silicic acid is a compound of the general formula (I), in which
X is selected from among NR[(CH₂)ₚNR¹]ᵢR², S(CH₂)ₑSH, S(CH₂)ᵤC(O)W, S(CH₂)ⱼNRC(S)NR¹H; in which W represents NH[(CH₂)ₚNH]ᵢH;
c and d are 0;
R and R¹ are independently selected from among hydrogen or C₁-alkyl; R² represents hydrogen;
R₃ and R₄ represent hydrogen;
u and i represent independently 1 or 2;
e, j and p represent independently 2 or 3;
the free valences of the oxygen atoms of the silicate are saturated by
one or multiple groups, which are selected from among a silicon atom of one of the other compounds of the general formula (I), hydrogen, a linear or branched C₁-C₁₂-alkyl group and an end group R⁵₃SiO_{1/2}, a cross-linking bridge member or a chain R⁵_{q}Si(OR⁶)_{g}O_{k/2} or Al(OR⁶)₃₋ₕO_{k/2} or R⁵Al(OR⁶)₂₋ᵣO_{r/2}, in which R⁵ and R⁶ are independently selected from among a linear or branched C₁-C₆-alkyl group, an aryl group and a C₁-C₂₂-alkylaryl group;
a and b represent whole numbers, so that the ratio b:a is between 0.00001 and 10.
claim 36: The method as recited in claim 31 wherein the surface-functionalized silicic acid is a surface-functionalized, pyrogenically manufactured silicic acid.
